(19) United States
(12) Patent Application Publication
(10) Pub. No.: US 2026/0081637 A1
(43) Pub. Date: Mar. 19, 2026

(54) RADIO FREQUENCY CIRCUIT

(71) Applicant: Murata Manufacturing Co., Ltd., Nagaokakyo-shi (JP)

(72) Inventor: Keisuke ARIMA, Nagaokakyo-shi (JP)

(73) Assignee: Murata Manufacturing Co., Ltd., Nagaokakyo-shi (JP)

(21) Appl. No.: 19/324,113

(22) Filed: Sep. 10, 2025

(30) Foreign Application Priority Data
Sep. 18, 2024 (JP) 2024-161001

(51) Int. Cl. H04B 1/40; H04B 1/00; H04B 1/04

(52) U.S. Cl. CPC H04B 1/40; H04B 1/0078; H04B 1/0458; H04B 2001/0408

(57) ABSTRACT

A radio frequency circuit include: a power amplifier circuit a harmonic attenuation circuit; a matching circuit; a filter; a first switch; a second switch; and a third switch. The matching circuit is coupled between the harmonic attenuation circuit and the power amplifier. The filter has an attenuation band including at least part of harmonic bands of a transmission band of a first band. The first switch is between the harmonic attenuation circuit and the filter. The second switch is between the filter and an antenna connection terminal. The third switch is between the matching circuit and the antenna connection terminal not via the harmonic attenuation circuit.

### CROSS-REFERENCE TO RELATED APPLICATION

The present application claims priority to Japanese patent application JP2024-161001, filed Sep. 18, 2024, the entire contents of which being incorporated herein by reference.

### BACKGROUND

### 1. Field

The present disclosure relates to a radio frequency circuit.

### 2. Description of the Related Art

International Publication No. 2021/117294 discloses a radio frequency module (a radio frequency circuit) including an output matching circuit coupled between an output end of a power amplifier and a switch.

### SUMMARY

A typical matching circuit coupled to an output end of a power amplifier circuit has not only the function of impedance conversion but also the function of harmonic attenuation. Therefore, when harmonic attenuation requirements are stringent, the increased pass band loss of radio frequency signals in the matching circuit (including a harmonic attenuation circuit) may become problematic.

Accordingly, the present disclosure is directed to providing a radio frequency circuit enabling a reduction of the pass band loss of radio frequency signals in a matching circuit (including a harmonic attenuation circuit) coupled to an output end of a power amplifier circuit.

A radio frequency circuit according to an aspect of the present disclosure includes: a power amplifier circuit; a harmonic attenuation circuit that has an attenuation band including at least part of harmonic bands of a transmission band of a first band; a matching circuit coupled between the harmonic attenuation circuit and the power amplifier circuit; a first filter that has a pass band including the transmission band of the first band; a first switch coupled between the harmonic attenuation circuit and the first filter; a second switch coupled between the first filter and an antenna connection terminal; and a third switch coupled between the matching circuit and the antenna connection terminal not via the harmonic attenuation circuit.

According to the present disclosure, it is possible to reduce the pass band loss of radio frequency signals in the matching circuit (including the harmonic attenuation circuit) coupled to the output end of the power amplifier circuit.

### BRIEF DESCRIPTION OF THE DRAWINGS

FIG. 1 is a circuit diagram of a communication device according to Embodiment 1;

FIG. 2 is a diagram illustrating a first mode of the communication device according to Embodiment 1;

FIG. 3 is a diagram illustrating a second mode of the communication device according to Embodiment 1;

FIG. 4 is a diagram illustrating a third mode of the communication device according to Embodiment 1;

FIG. 5A is a circuit diagram of a harmonic attenuation circuit according to Modification 1 of Embodiment 1;

FIG. 5B is a circuit diagram of a harmonic attenuation circuit according to Modification 2 of Embodiment 1;

FIG. 5C is a circuit diagram of a harmonic attenuation circuit according to Modification 3 of Embodiment 1;

FIG. 6 is a circuit diagram of a communication device according to Embodiment 2;

FIG. 7 is a diagram illustrating a first mode of the communication device according to Embodiment 2;

FIG. 8 is a diagram illustrating a second mode of the communication device according to Embodiment 2;

FIG. 9 is a diagram illustrating a third mode of the communication device according to Embodiment 2; and

FIG. 10 a diagram illustrating a fourth mode of the communication device according to Embodiment 2.

### DETAILED DESCRIPTION

Hereinafter, embodiments are described in detail with reference to the drawings. Each of the embodiments described below illustrates an inclusive or specific example. The numerical values, shapes, materials, constituent elements, and arrangements and connections of the constituent elements described in the following embodiments are examples and are not intended to limit the present disclosure.

Each drawing is a schematic diagram with emphasis, omission, or ratio adjustment performed as appropriate to illustrate the present disclosure and is not necessarily an exactly illustrated diagram. The shapes, positional relationships, and ratios in each drawing may differ from actual ones. In each drawing, substantially identical components are indicated by the same reference numerals, and redundant descriptions may be omitted or simplified.

In the following description, “be coupled” includes not only “be directly coupled by connection terminals and/or wiring conductors”, but also “be electrically coupled via another circuit element.” “Be coupled between A and B” means “be coupled to both A and B between A and B” and means “be arranged in series in the path connecting A and B.” “C is coupled between A and B” means that one end of C is coupled to A while the other end of C is coupled to B and means that C is arranged in series in the path connecting A and B. The “path connecting A and B” means a path composed of a conductor electrically coupling A to B.

The “pass band of a filter” refers to the portion of a frequency spectrum transmitted by the filter and is defined as a frequency range between the two frequencies where the power insertion loss is 3 dB greater than the minimum power insertion loss.

The “attenuation band of a harmonic attenuation circuit” refers to the portion of the frequency spectrum attenuated by the harmonic attenuation circuit and is defined as a frequency range where the power insertion loss is at least 5 dB greater than the minimum power insertion loss.

“Transmission band” refers to a frequency band used for transmission in the communication device, and “reception band” refers to a frequency band used for reception in the communication device. In a frequency division duplex (FDD) band, for example, the transmission and reception bands use different frequency bands (uplink and downlink bands). In a time division duplex (TDD) band, for example, the transmission and reception bands use the same frequency band.

The “harmonic band of a given band” refers to a frequency range from n times the lower end of the given band to n times the upper end of the given band. Herein, n is a natural number not less than 2. For example, a second-order harmonic band of a given band is a frequency range from twice the lower end of the given band to twice the upper end of the given band, and a third-order harmonic band of a given band is a frequency range from three times the lower end of the given band to three times the upper end of the given band. “Harmonic bands”, when used without the order, refer to harmonic bands of all orders.

“Terminal” refers to the point where a conductor within a circuit element ends. When a conductor between circuit elements has a sufficiently low impedance, “terminal” is interpreted not only as a single point but also as any point on the conductor between the circuit elements or the entire conductor.

“Node” refers to a point on a conductor between circuit elements. When the conductor between the circuit elements has a sufficiently low impedance, “node” is interpreted not only as a single point but also as any point on the conductor between the circuit elements or the entire conductor.

“Power class” refers to a classification of output power of user equipment (UE) that is specified by the maximum output power. The smaller the value of the power class, the higher the maximum output power that is permitted. In the 3rd Generation Partnership Project (3GPP (registered trademark)), for example, Power Classes 1, 1.5, 2, and 3 are specified. Specifically, the maximum output power specified for Power Class 1 is 31 dBm; Power Class 1.5, 29 dBm; Power Class 2, 26 dBm; and Power Class 3, 23 dBm.

The UE maximum output power is defined as the maximum output power at the antenna end. The UE maximum output power is measured by a method defined by 3GPP or the like.

For example, the maximum output power is measured by measuring the radiated power at the antenna. Instead of measuring the radiated power, the maximum output power of the antenna may be measured by placing a terminal in the vicinity of the antenna and connecting the terminal to a measurement device, such as a spectrum analyzer.

The “band corresponding to a given power class” refers to a frequency band permitted to use that power class and is defined by standards or the like. For example, in the 3GPP Release 17, the bands defined corresponding to Power Class 2 include n1, n3, n34, n39, n40, n41, n77, n78, n79, n95, n97, n98, and n104 for 5G NR, and the bands defined corresponding to Power Class 1.5 include n41, n77, n78, and n79 for 5G NR.

### Embodiment 1

Hereinafter, Embodiment 1 is described.

### 1.1. Circuit Configuration of Communication Device

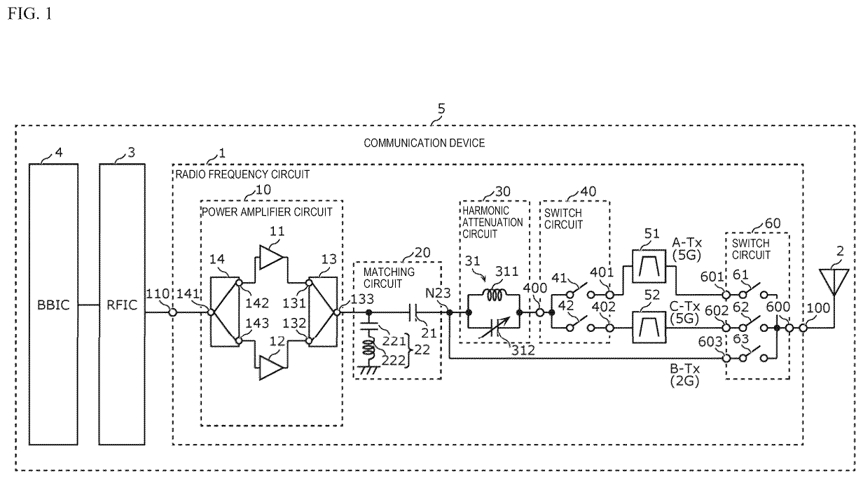

First, the circuit configuration of a communication device 5 according to Embodiment 1 is described with reference to FIG. 1. FIG. 1 is a circuit diagram of the communication device 5 according to Embodiment 1.

FIG. 1 illustrates an exemplary circuit configuration. The communication device 5 can be implemented using any of a wide variety of circuit implementations and circuit technologies. Therefore, the following description of the communication device 5 is not limiting.

The communication device 5 can be used to provide wireless connections. The communication device 5 can be implemented in UE within a cellular network (also referred to as a mobile network), for example, mobile phones, smartphones, tablet computers, and wearable devices. In another example, implementing the communication device 5 can provide wireless connections for Internet of Things (IoT) sensor devices, medical and healthcare devices, vehicles, unmanned aerial vehicles (UAVs), that is, so-called drones, and automated guided vehicles (AGVs). In yet another example, implementing the communication device 5 can provide wireless connections at wireless access points or wireless hot spots.

The communication device 5 includes a radio frequency circuit 1, an antenna 2, a radio frequency integrated circuit (RFIC) 3, and a baseband integrated circuit (BBIC) 4.

The radio frequency circuit 1 is coupled between the antenna 2 and the RFIC 3. The radio frequency circuit 1 is able to transmit radio frequency signals between the antenna 2 and the RFIC 3. The circuit configuration of the radio frequency circuit 1 is described in detail later.

The antenna 2 is coupled to the radio frequency circuit 1. The antenna 2 is able to receive a radio frequency signal from the radio frequency circuit 1 and transmit the received radio frequency signal to the outside of the communication device 5. The antenna 2 may receive a radio frequency signal from the outside of the communication device 5 and supply the received radio frequency signal to the radio frequency circuit 1. The antenna 2 may not be included in the communication device 5. The communication device 5 may further include one or more antennas in addition to the antenna 2.

The RFIC 3 is an example of a signal processing circuit to process radio frequency signals. Specifically, the RFIC 3 is able to perform up conversion or other signal processing for a transmission signal inputted from the BBIC 4 and output a radio frequency transmission signal generated by the above signal processing to the radio frequency circuit 1. Furthermore, the RFIC 3 may perform down conversion or other signal processing for a radio frequency reception signal inputted through a receive path of the radio frequency circuit 1 and output a reception signal generated by the above signal processing to the BBIC 4. The RFIC 3 may include a controller that controls a switch circuit, a power amplifier circuit, and other elements included in the radio frequency circuit 1. Some or all of the functions of the RFIC 3 as the controller may be included outside of the RFIC 3, for example, in the BBIC 4 or the radio frequency circuit 1.

The BBIC 4 is a baseband signal processing circuit that performs signal processing using a frequency band lower than that of radio frequency signals transmitted by the radio frequency circuit 1. The signals to be processed by the BBIC 4 include, for example, image signals for image display and/or audio signals for telephone calls through speakers.

The BBIC 4 may not be partially or entirely included in the communication device 5.

### 1.2. Circuit Configuration of Radio Frequency Circuit 1

Next, the circuit configuration of the radio frequency circuit 1 according to Embodiment 1 is described with reference to FIG. 1. FIG. 1 illustrates an exemplary circuit configuration, and the radio frequency circuit 1 can be implemented using any of a wide variety of circuit implementations and circuit technologies. The following description of the radio frequency circuit 1 is not limiting.

The radio frequency circuit 1 includes a power amplifier circuit 10, a matching circuit 20, a harmonic attenuation circuit 30, switch circuits 40 and 60, filters 51 and 52, an antenna connection terminal 100, and an RF input terminal 110.

The antenna connection terminal 100 is an external connection terminal of the radio frequency circuit 1 and supplies a radio frequency signal to the antenna 2. The antenna connection terminal 100 is coupled to the antenna 2 outside the radio frequency circuit 1 and is coupled to the switch circuit 60 inside the radio frequency circuit 1.

The RF input terminal 110 is an external connection terminal of the radio frequency circuit 1 and receives a radio frequency signal from the RFIC 3. The RF input terminal 110 is coupled to the RFIC 3 outside the radio frequency circuit 1 and is coupled to the power amplifier circuit 10 inside the radio frequency circuit 1.

### 1.2.1. Power Amplifier Circuit 10

The power amplifier circuit 10 is coupled between the RF input terminal 110 and the matching circuit 20. Specifically, the input end of the power amplifier circuit 10 is coupled to the RF input terminal 110, while the output end of the power amplifier circuit 10 is coupled to the matching circuit 20. The power amplifier circuit 10 is able to amplify a radio frequency signal using power supplied from a power source (not illustrated).

In Embodiment 1, the power amplifier circuit 10 is an amplifier circuit including two power amplifiers coupled in parallel and is, for example, a differential, balanced, or Doherty amplifier circuit. The power amplifier circuit 10 includes power amplifiers 11 and 12, a combiner 13, and a power splitter 14.

The power amplifier 11 is an example of a first power amplifier and is coupled between the power splitter 14 and the combiner 13. Specifically, the input end of the power amplifier 11 is coupled to an output terminal 142 of the power splitter 14, while the output end of the power amplifier 11 is coupled to an input terminal 131 of the combiner 13.

The power amplifier 12 is an example of a second power amplifier and is coupled between the power splitter 14 and the combiner 13. Specifically, the input end of the power amplifier 12 is coupled to an output terminal 143 of the power splitter 14, while the output end of the power amplifier 12 is coupled to an input terminal 132 of the combiner 13.

The combiner 13 is coupled between the matching circuit 20 and the power amplifiers 11 and 12. Specifically, the combiner 13 includes the input terminals 131 and 132 and an output terminal 133. The input terminal 131 is an example of a first input terminal and is coupled to the output end of the power amplifier 11. The input terminal 132 is an example of a second input terminal and is coupled to the output end of the power amplifier 12. The output terminal 133 is coupled to the matching circuit 20. The combiner 13 can be composed of, for example, a transformer, a 90-degree hybrid coupler, a 180-degree hybrid coupler, or a Wilkinson coupler and is not limited.

The power splitter 14 is coupled between the RF input terminal 110 and the power amplifiers 11 and 12.

Specifically, the power splitter 14 includes: an input terminal 141, which is coupled to the RF input terminal 110; the output terminal 142, which is coupled to the input end of the power amplifier 11; and the output terminal 143, which is coupled to the input end of the power amplifier 12. The power splitter 14 can be composed of, for example, a transformer, a 90-degree hybrid coupler, a 180-degree hybrid coupler, or a Wilkinson coupler and is not limited. The power splitter 14 may not be included in the power amplifier circuit 10 and may not be included in the radio frequency circuit 1.

The thus-configured power amplifier circuit 10 can be partially or entirely implemented in a semiconductor integrated circuit. The semiconductor material of the semiconductor integrated circuit can be, for example, silicon germanium (SiGe) or gallium arsenide (GaAs). In this case, the power amplifiers 11 and 12 can be partially or entirely composed of a heterojunction bipolar transistor (HBT). The semiconductor material of the power amplifier circuit 10 can be gallium nitride (GaN) or silicon carbide (SiC). In this case, the power amplifiers 11 and 12 can be partially or entirely composed of a high electron mobility transistor (HEMT) or a metal-semiconductor field effect transistor (MESFET). The semiconductor material of the power amplifier circuit 10 can be a silicon single crystal (Si). In this case, the power amplifiers 11 and 12 may be partially or entirely composed of a complementary metal oxide semiconductor (CMOS) and may be manufactured by a silicon on insulator (SOI) process. The power amplifier circuit 10 may be implemented by being divided into a plurality of semiconductor integrated circuits.

The power amplifier circuit 10 may be a multistage amplification circuit. In this case, the power amplifier circuit 10 may further include a power amplifier coupled between the RF input terminal 110 and the power splitter 14. The power amplifier circuit 10 may not include the two power amplifiers coupled in parallel. In this case, the power amplifier circuit 10 may not include the power amplifier 12, the combiner 13, and the power splitter 14.

### 1.2.2. Matching Circuit 20

The matching circuit 20 is coupled between the power amplifier circuit 10 and the antenna connection terminal 100. Specifically, the input end of the matching circuit 20 is coupled to the power amplifier circuit 10, while the output end of the matching circuit 20 is coupled to the harmonic attenuation circuit 30 and the switch circuit 60.

The matching circuit 20 is able to provide impedance matching between the power amplifier circuit 10 and the harmonic attenuation circuit 30 and between the power amplifier circuit 10 and the switch circuit 60. In Embodiment 1, the matching circuit 20 includes a capacitor 21 and an LC series circuit 22.

The capacitor 21 serves as a so-called direct current (DC) cut capacitor or a coupling capacitor, and is coupled between the power amplifier circuit 10 and the harmonic attenuation circuit 30. Specifically, one of the two electrodes of the capacitor 21 is coupled to the output end of the power amplifier circuit 10, while the other of the two electrodes of the capacitor 21 is coupled to the input end of the harmonic attenuation circuit 30.

The LC series circuit 22 is coupled between ground and the path connecting the power amplifier circuit 10 and the harmonic attenuation circuit 30. The LC series circuit 22 includes a capacitor 221 and an inductor 222, which are coupled in series.

The circuit configuration of the matching circuit 20 is not limited to that illustrated in FIG. 1. For example, the LC series circuit 22 may be coupled between ground and the path connecting the capacitor 21 and the harmonic attenuation circuit 30.

### 1.2.3. Harmonic Attenuation Circuit 30

The harmonic attenuation circuit 30 has an attenuation band that includes at least part of the harmonic bands of the transmission bands of bands A and C. The harmonic attenuation circuit 30 is coupled between the matching circuit 20 and the switch circuit 40. Specifically, the input end of the harmonic attenuation circuit 30 is coupled to the output end of the matching circuit 20, while the output end of the harmonic attenuation circuit 30 is coupled to a common terminal 400 of the switch circuit 40. The harmonic attenuation circuit 30 is able to attenuate the harmonics of signals in the bands A and C.

In Embodiment 1, the harmonic attenuation circuit 30 includes an LC parallel circuit 31, which is coupled between the matching circuit 20 and the switch circuit 40. The harmonic attenuation circuit 30 does not include a ground connection. That is, the harmonic attenuation circuit 30 does not include any active or passive element that is coupled between ground and the path connecting the matching circuit 20 and the switch circuit 40.

The LC parallel circuit 31 includes an inductor 311 and a capacitor 312, which are coupled in parallel between the matching circuit 20 and the switch circuit 40. The capacitor 312 is a variable capacitor whose electrostatic capacity can be varied.

The circuit configuration of the harmonic attenuation circuit 30 is not limited to that illustrated in FIG. 1.

For example, the capacitor 312 may not be a variable capacitor and may be a fixed capacitor.

### 1.2.4. Switch Circuit 40

The switch circuit 40 is coupled between the harmonic attenuation circuit 30 and the filters 51 and 52.

Specifically, the switch circuit 40 includes the common terminal 400, selection terminals 401 and 402, and switches 41 and 42. The common terminal 400 is coupled to the output end of the harmonic attenuation circuit 30. The selection terminal 401 is coupled to the filter 51. The selection terminal 402 is coupled to the filter 52. When the filter 52 is not included in the radio frequency circuit 1, the selection terminal 402 may not be included in the switch circuit 40.

The switch 41 is an example of a first switch and is coupled between the common terminal 400 and the selection terminal 401. That is, the switch 41 is coupled between the harmonic attenuation circuit 30 and the filter 51.

The switch 42 is an example of a fourth switch and is coupled between the common terminal 400 and the selection terminal 402. That is, the switch 42 is coupled between the harmonic attenuation circuit 30 and the filter 52. When the filter 52 is not included in the radio frequency circuit 1, the switch 42 may not be included in the switch circuit 40. In such a connection configuration, the switch circuit 40 controls the switches 41 and 42 based on, for example, a control signal from the RFIC 3 to selectively connect the common terminal 400 to the selection terminals 401 and 402. That is, the switch circuit 40 is able to switch the connection of the harmonic attenuation circuit 30 between the filters 51 and 52. The thus-configured switch circuit 40 is composed of, for example, a single-pole double-throw (SPDT) switch circuit.

The switch circuit 40 can be implemented in a semiconductor integrated circuit. The semiconductor material of the semiconductor integrated circuit can be, for example, a silicon single crystal (Si), gallium nitride (GaN), or silicon carbide (SiC). The switches 41 and 42 can be partially or entirely composed of a field effect transistor (FET). Alternatively, a bipolar transistor may be used instead of a FET. The switch circuit 40 may be implemented by being divided into a plurality of semiconductor integrated circuits.

The circuit configuration of the switch circuit 40 is not limited to that illustrated in FIG. 1. The switch circuit 40 may further include one or more additional common terminals and/or one or more additional selection terminals. In this case, the switch circuit 40 may further include one or more additional switches. For example, the switch circuit 40 may further include a switch coupled between the matching circuit 20 and the switch circuit 60 not via the harmonic attenuation circuit 30.

### 1.2.5. Filters 51 and 52

The filter 51 is an example of a first filter and is a band pass filter that has a pass band including the transmission band of the band A. The filter 51 is coupled between the switch circuits 40 and 60. Specifically, one end of the filter 51 is coupled to the selection terminal 401 of the switch circuit 40, while the other end of the filter 51 is coupled to a selection terminal 601 of the switch circuit 60.

The filter 52 is an example of a second filter and is a band pass filter that has a pass band including the transmission band of the band C. The filter 52 is coupled between the switch circuits 40 and 60. Specifically, one end of the filter 52 is coupled to the selection terminal 402 of the switch circuit 40, while the other end of the filter 52 is coupled to a selection terminal 602 of the switch circuit 60. The filter 52 may not be included in the radio frequency circuit 1.

Each of the filters 51 and 52 may be a surface acoustic wave (SAW) filter, a bulk acoustic wave (BAW) filter, an LC filter, a dielectric filter, or any combination thereof and is not limited to these filters.

The filters 51 and 52 are not limited to band pass filters. The filters 51 and 52 may be partially or entirely composed of a band elimination filter, a high pass filter, or a low pass filter.

The radio frequency circuit 1 may further include an additional filter. For example, the radio frequency circuit 1 may include an additional filter coupled between the matching circuit 20 and the switch 63.

### 1.2.6. Switch Circuit 60

The switch circuit 60 is coupled between the antenna connection terminal 100 and the filters 51 and 52 and between the antenna connection terminal 100 and the matching circuit 20. Specifically, the switch circuit 60 includes a common terminal 600, the selection terminals 601 and 602, a selection terminal 603, and the switches 61, 62, and 63.

The common terminal 600 is coupled to the antenna connection terminal 100. The selection terminal 601 is coupled to the filter 51. The selection terminal 602 is coupled to the filter 52. When the filter 52 is not included in the radio frequency circuit 1, the selection terminal 602 is not needed. The selection terminal 603 is coupled to the matching circuit 20 not via the harmonic attenuation circuit 30. Specifically, the selection terminal 603 is coupled to a node N23 on the path connecting the matching circuit 20 and the harmonic attenuation circuit 30. Thus, the switch circuit 60 is configured to selectively couple the antenna connection terminal 100 to the filters 51 and 52, and to the matching circuit 20.

The switch 61 is an example of a second switch and is coupled between the common terminal 600 and the selection terminal 601. That is, the switch 61 is coupled between the antenna connection terminal 100 and the filter 51.

The switch 62 is an example of a fifth switch and is coupled between the common terminal 600 and the selection terminal 602. That is, the switch 62 is coupled between the antenna connection terminal 100 and the filter 52. When the filter 52 is not included in the radio frequency circuit 1, the switch 62 may not be included in the switch circuit 60. The switch 63 is an example of a third switch and is coupled between the common terminal 600 and the selection terminal 603. That is, the switch 63 is coupled between the antenna connection terminal 100 and the matching circuit 20 not via the harmonic attenuation circuit 30. The switch 63 may not be included in the switch circuit 60. For example, the switch 63 may be included in the switch circuit 40.

In such a connection configuration, the switch circuit 60 controls the switches 61 to 63 based on, for example, a control signal from the RFIC 3 to selectively connect the common terminal 600 to the selection terminals 601 to 603. That is, the switch circuit 60 is able to switch the connection of the antenna connection terminal 100 between the filter 51, the filter 52, and the matching circuit 20. The thus-configured switch circuit 60 is composed of, for example, a single-pole triple-throw (SP3T) switch circuit.

The switch circuit 60 can be implemented in a semiconductor integrated circuit. The semiconductor material of the semiconductor integrated circuit can be, for example, a silicon single crystal (Si), gallium nitride (GaN), or silicon carbide (SiC). In this case, the switches 61 to 63 may be partially or entirely composed of an FET. Alternatively, a bipolar transistor may be used instead of an FET. The switch circuit 60 may be implemented by being divided into a plurality of semiconductor integrated circuits or implemented in the same semiconductor integrated circuit as the switch circuit 40.

The circuit configuration of the switch circuit 60 is not limited to that illustrated in FIG. 1. The switch circuit 60 may further include one or more additional common terminals and/or one or more additional selection terminals. In this case, the switch circuit 60 may further include one or more additional switches.

### 1.3. Frequency Band

Herein, the bands A, B, and C supported by the communication device 5 are described.

The bands A to C are frequency bands for communication systems built using radio access technology (RAT). The bands A to C are predefined by a standardizing body, such as 3GPP or Institute of Electrical and Electronics Engineers (IEEE). Examples of the communication systems include 5th Generation New Radio (5G NR) systems, 4th Generation Long Term Evolution (4G LTE) systems, and 2nd Generation Global System for Mobile Communications (2G GSM) systems.

In Embodiment 1, the bands A and C are examples of a first band and a third band, respectively, and are 5G NR bands. The band A and/or C may be 4G LTE bands.

In Embodiment 1, the band B is an example of a second band and is a 2G GSM band. The band B may be a 5G NR band or a 4G LTE band. In this case, the maximum output power of transmission signals in the band B may be smaller than that of transmission signals in the bands A and C. That is, the band B may operate in a low-power mode (LPM).

### 1.4. Plurality of Communication Modes of Communication Device 5

Next, a plurality of communication modes of the communication device 5 is described.

### 1.4.1. First Mode

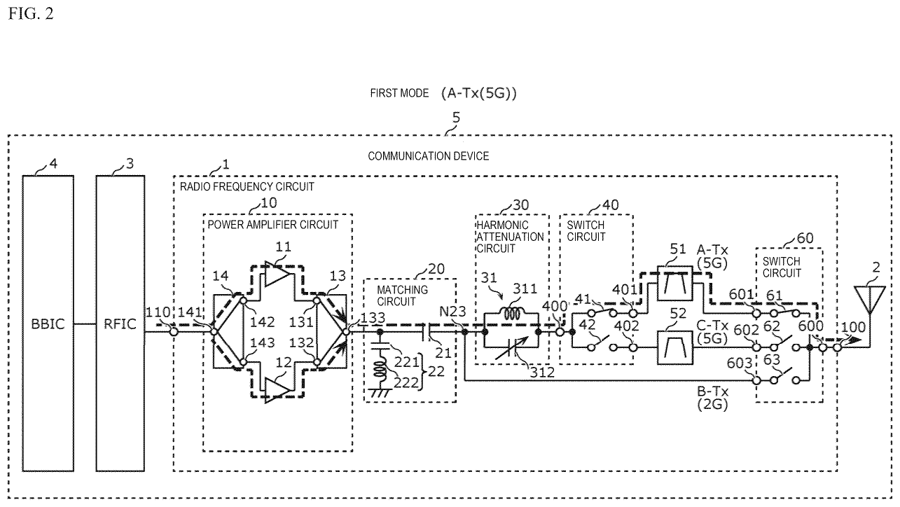

First, a first mode included in the plurality of communication modes is described with reference to FIG. 2. The first mode is a communication mode for transmitting a radio frequency signal (an example of a first radio frequency signal) in the transmission band of the band A. In the first mode, the first radio frequency signal is routed through a primary signal path that includes the harmonic attenuation circuit 30 to ensure attenuation of harmonics.

In the first mode, the switch circuit 40 connects the common terminal 400 to the selection terminal 401 and does not connect the common terminal 400 to the selection terminal 402. That is, the switch 41 is closed, while the switch 42 is opened. The switch circuit 60 connects the common terminal 600 to the selection terminal 601, and does not connect the common terminal 600 to the selection terminal 602 or 603. That is, the switch 61 is closed, while the switches 62 and 63 are opened.

Therefore, a transmission signal in the band A is transmitted from the RFIC 3 to the antenna 2 via the RF input terminal 110, the power amplifier circuit 10, the matching circuit 20, the harmonic attenuation circuit 30, the switch circuit 40, the filter 51, the switch circuit 60, and the antenna connection terminal 100.

During this process, the capacitor 312 of the harmonic attenuation circuit 30 is controlled to a first electrostatic capacity, so that the resonant frequency of the LC parallel circuit 31 is included in the harmonic bands of the transmission band of the band A. As a result, the harmonic attenuation circuit 30 can effectively attenuate signals in the harmonic bands of the transmission band of the band A.

### 1.4.2. Second Mode

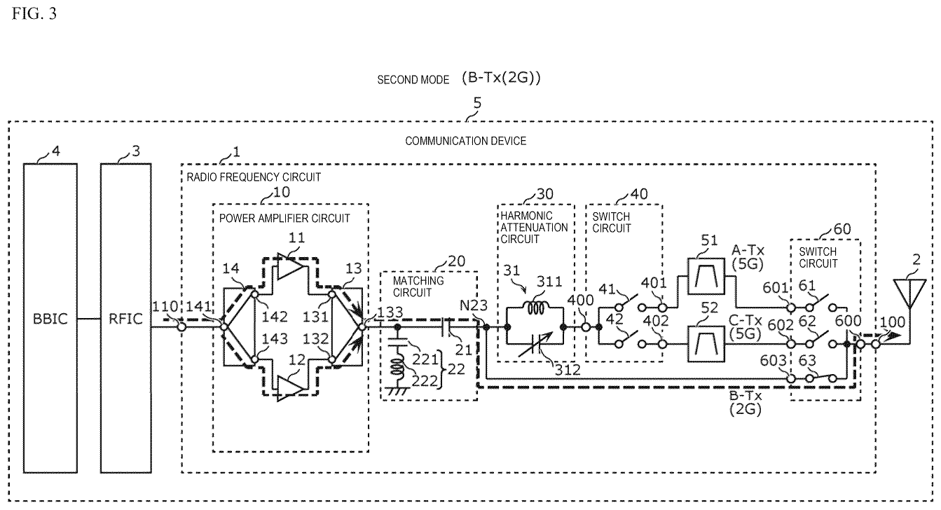

Next, a second mode included in the plurality of communication modes is described with reference to FIG. 3. The second mode is a communication mode for transmitting a radio frequency signal (an example of a second radio frequency signal) in the transmission band of the band B. In the second mode, the second radio frequency signal is routed through a bypass signal path that does not include the harmonic attenuation circuit 30, thereby reducing pass band loss for the second radio frequency signal

In the second mode, the switch circuit 40 does not connect the common terminal 400 to the selection terminal 401 or 402. That is, the switches 41 and 42 are opened.

The switch circuit 60 connects the common terminal 600 to the selection terminal 603 and does not connect the common terminal 600 to the selection terminal 601 or 602. That is, the switch 63 is closed, while the switches 61 and 62 are opened.

Therefore, a transmission signal in the band B is transmitted from the RFIC 3 to the antenna 2 via the RF input terminal 110, the power amplifier circuit 10, the matching circuit 20, the switch circuit 60, and the antenna connection terminal 100. That is, the transmission signal in the band B is transmitted to the antenna 2 without passing through the harmonic attenuation circuit 30.

During this process, the capacitor 312 of the harmonic attenuation circuit 30 is controlled to a second electrostatic capacity, which is greater than the first electrostatic capacity. The resonant frequency of the LC parallel circuit 31 is thereby included in the transmission band of the band B. This can increase the impedance of the harmonic attenuation circuit 30 in the transmission band of the band B and reduce the voltage applied to the common terminal 400 of the switch circuit 40.

### 1.4.3. Third Mode

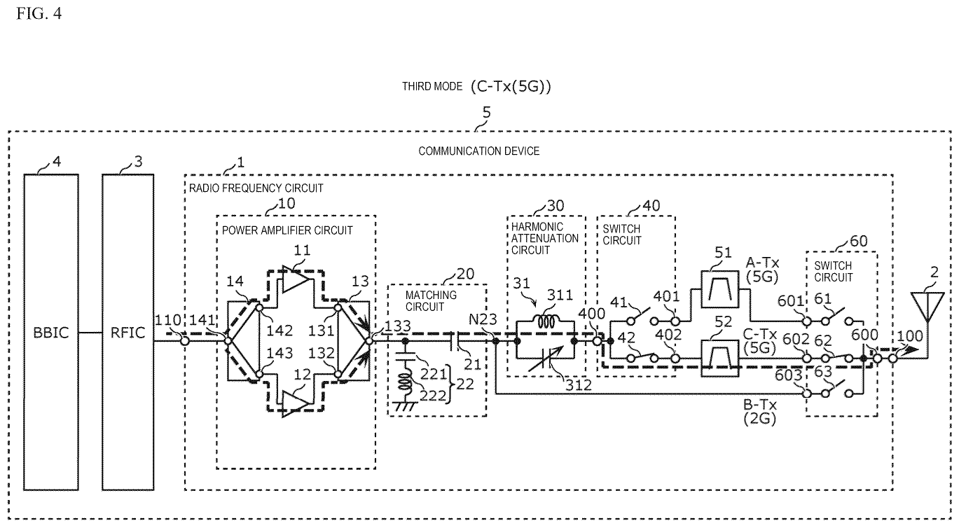

Next, a third mode included in the plurality of communication modes is described with reference to FIG. 4. The third mode is a communication mode for transmitting a radio frequency signal (an example of a third radio frequency signal) in the transmission band of the band C. In the third mode, the third radio frequency signal is routed through a primary signal path that includes the harmonic attenuation circuit 30 to ensure attenuation of harmonics.

In the third mode, the switch circuit 40 connects the common terminal 400 to the selection terminal 402 and does not connect the common terminal 400 to the selection terminal 401. That is, the switch 42 is closed, while the switch 41 is opened. Furthermore, the switch circuit 60 connects the common terminal 600 to the selection terminal 602 and does not connect the common terminal 600 to the selection terminal 601 or 603. That is, the switch 62 is closed, while the switches 61 and 63 are opened.

Therefore, a transmission signal in the band C is transmitted from the RFIC 3 to the antenna 2 via the RF input terminal 110, the power amplifier circuit 10, the matching circuit 20, the harmonic attenuation circuit 30, the switch circuit 40, the filter 52, the switch circuit 60, and the antenna connection terminal 100.

During this process, the capacitor 312 of the harmonic attenuation circuit 30 is controlled to a third electrostatic capacity, so that the resonant frequency of the LC parallel circuit 31 is included in the harmonic bands of the transmission band of the band C. As a result, the harmonic attenuation circuit 30 can effectively attenuate signals in the harmonic bands of the transmission band of the band C.

### 1.5. Conclusion

As described above, the radio frequency circuit 1 according to Embodiment 1 includes: the power amplifier circuit 10; the harmonic attenuation circuit 30, which has an attenuation band including at least part of the harmonic bands of the transmission band of the band A; the matching circuit 20, which is coupled between the harmonic attenuation circuit 30 and the power amplifier circuit 10; the filter 51, which has a pass band including the transmission band of the band A; the switch 41, which is coupled between the harmonic attenuation circuit 30 and the filter 51; the switch 61, which is coupled between the filter 51 and the antenna connection terminal 100; and the switch 63, which is coupled between the matching circuit 20 and the antenna connection terminal 100 not via the harmonic attenuation circuit 30.

According to such a configuration, the matching circuit coupled to the output end of the power amplifier circuit 10 is divided into the matching circuit 20 and the harmonic attenuation circuit 30, thereby implementing the transmit path that couples the matching circuit 20 to the antenna connection terminal 100 not via the harmonic attenuation circuit 30. The transmit path that couples the matching circuit 20 to the antenna connection terminal 100 via the harmonic attenuation circuit 30 and the transmit path that couples the matching circuit 20 to the antenna connection terminal 100 not via the harmonic attenuation circuit 30 are switched by the switches 41, 61, and 63. Therefore, radio frequency signals with stringent harmonic attenuation requirements are transmitted using the transmit path that couples the matching circuit 20 to the antenna connection terminal 100 via the harmonic attenuation circuit 30. This can satisfy the harmonic attenuation requirements. On the other hand, radio frequency signals with less stringent harmonic attenuation requirements are transmitted using the transmit path that couples the matching circuit 20 to the antenna connection terminal 100 not via the harmonic attenuation circuit 30. This can reduce the pass band loss of radio frequency signals in the harmonic attenuation circuit 30. That is, the radio frequency circuit 1 can reduce the pass band loss of radio frequency signals in the harmonic attenuation circuit 30 while satisfying harmonic attenuation requirements.

In the radio frequency circuit 1 according to Embodiment 1, for example, the harmonic attenuation circuit 30 may include the inductor 311, which is coupled between the matching circuit 20 and the switch 41, and may not include a ground connection.

According to such a configuration, the harmonic attenuation circuit 30 does not include a ground connection. Therefore, when the switch 41 is opened and the switch 63 is closed, the influence of the harmonic attenuation circuit 30 on the signal path for the band B can be reduced even if the harmonic attenuation circuit 30 does not include a switch.

Furthermore, because the inductor 311 is coupled between the matching circuit 20 and the switch 41, the pass band loss in the inductor 311 is high, and the pass band loss of radio frequency signals in the harmonic attenuation circuit 30 can be reduced effectively.

In the radio frequency circuit 1 according to Embodiment 1, for example, in the first mode for transmitting the first radio frequency signal in the transmission band of the band A, the switches 41 and 61 may be closed, and the switch 63 may be opened. In the second mode for transmitting the second radio frequency signal in the transmission band of the band B, the switch 63 may be closed, and the switches 41 and 61 may be opened.

According to such a configuration, by using the first mode when the harmonic attenuation requirements are stringent, the first radio frequency signal can be transmitted via the harmonic attenuation circuit 30. On the other hand, by using the second mode when the harmonic attenuation requirements are less stringent, the second radio frequency signal can be transmitted without passing through the harmonic attenuation circuit 30. Therefore, during the transmission of the first radio frequency signal with stringent harmonic attenuation requirements, the harmonic attenuation requirements are satisfied, and during the transmission of the second radio frequency signal with less stringent harmonic attenuation requirements, the pass band loss of the second radio frequency signal in the harmonic attenuation circuit 30 can be reduced.

In the radio frequency circuit 1 according to Embodiment 1, for example, the band A may be a 5G NR band or a 4G LTE band, and the band B may be a 2G GSM band.

According to such a configuration, the first radio frequency signal in the 5G NR band or the 4G LTE band with stringent harmonic attenuation requirements can be transmitted using the first mode, and the second radio frequency signal of the 2G GSM band with less stringent harmonic attenuation requirements can be transmitted using the second mode.

In the radio frequency circuit 1 according to Embodiment 1, for example, the bands A and B can be 5G NR bands or 4G LTE bands, and the maximum output power of the first radio frequency signal may be higher than that of the second radio frequency signal.

According to such a configuration, signal loss can be reduced by using the second mode in the low-power mode (LPM), where a lower maximum output power is applied and the harmonic attenuation requirements are less stringent.

For example, the radio frequency circuit 1 according to Embodiment 1 may further include: the filter 52, which has a pass band including the transmission band of the band C; the switch 42, which is coupled between the harmonic attenuation circuit 30 and the filter 52; and the switch 62, which is coupled between the filter 52 and the antenna connection terminal 100.

According to such a configuration, the radio frequency signal of the band C can be transmitted via the harmonic attenuation circuit 30. Therefore, the harmonic attenuation requirements can be satisfied during the transmission of signals in the band C, in addition to the band A, and during the transmission of signals in the band B, the pass band loss of signals in the band B in the harmonic attenuation circuit 30 can be reduced.

In the radio frequency circuit 1 according to Embodiment 1, for example, in the third mode for transmitting the third radio frequency signal in the transmission band of the band C, the switches 42 and 62 may be closed, and the switches 41, 61, and 63 may be opened.

According to such a configuration, by using the third mode when the harmonic attenuation requirements are stringent, the third radio frequency signal can be transmitted via the harmonic attenuation circuit 30.

In the radio frequency circuit 1 according to Embodiment 1, for example, the harmonic attenuation circuit 30 may include the LC parallel circuit 31, which is coupled between the matching circuit 20 and the switch 41.

According to such a configuration, the harmonics can be attenuated by the LC parallel circuit 31.

In the radio frequency circuit 1 according to Embodiment 1, for example, the capacitor 312 of the LC parallel circuit 31 may be a variable capacitor.

According to such a configuration, the electrostatic capacity of the capacitor 312 of the LC parallel circuit 31 can be varied.

In the radio frequency circuit 1 according to Embodiment 1, for example, in the first mode for transmitting the first radio frequency signal in the transmission band of the band A, the capacitor 312 may be controlled to the first electrostatic capacity. In the second mode for transmitting the second radio frequency signal in the transmission band of the band B, the capacitor 312 may be controlled to the second electrostatic capacity, which is greater than the first electrostatic capacity.

According to such a configuration, the attenuation band of the harmonic attenuation circuit 30 can be varied by changing the electrostatic capacity of the capacitor 312.

In the radio frequency circuit 1 according to Embodiment 1, for example, in the first mode for transmitting the first radio frequency signal in the transmission band of the band A, the capacitor 312 may be controlled to the first electrostatic capacity so that the resonant frequency of the LC parallel circuit 31 is included in the harmonic bands of the transmission band of the band A. In the second mode for transmitting the second radio frequency signal in the transmission band of the band B, the capacitor 312 may be controlled to the second electrostatic capacity so that the resonant frequency of the LC parallel circuit 31 is included in the transmission band of the band B.

According to such a configuration, in the first mode, the resonant frequency of the LC parallel circuit 31 is included in the harmonic bands of the transmission band of the band A. This can effectively attenuate radio frequency distortion of the first radio frequency signal. In the second mode, the resonant frequency of the LC parallel circuit 31 is included in the transmission band of the band B. This can increase the impedance of the LC parallel circuit 31 in the transmission band of the band B and reduce the voltage applied to the switches 41 and 42. As a result, the required voltage withstand capability of the switches 41 and 42 can be reduced, which contributes to the reduction in size of the switches 41 and 42.

In the radio frequency circuit 1 according to Embodiment 1, for example, the matching circuit 20 may include the capacitor 21, which is coupled between the power amplifier circuit 10 and the harmonic attenuation circuit 30.

According to such a configuration, the direct-current component can be cut off by the matching circuit 20.

In the radio frequency circuit 1 according to Embodiment 1, for example, the matching circuit 20 may include the LC series circuit 22, which is coupled between ground and the path connecting the power amplifier circuit 10 and the harmonic attenuation circuit 30.

According to such a configuration, radio frequency distortion can be attenuated by the matching circuit 20 as well.

In the radio frequency circuit 1 according to Embodiment 1, for example, the power amplifier circuit 10 may include: the power amplifiers 11 and 12, the input terminal 131, which is coupled to the output end of the power amplifier 11; the input terminal 132, which is coupled to the output end of the power amplifier 12; and the combiner 13, which includes the output terminal 133 coupled to the matching circuit 20.

According to such a configuration, radio frequency signals can be amplified by the power amplifiers 11 and 12, which are coupled in parallel, thereby enabling the radio frequency circuit 1 to accommodate higher output power.

### Modification 1 of Embodiment 1

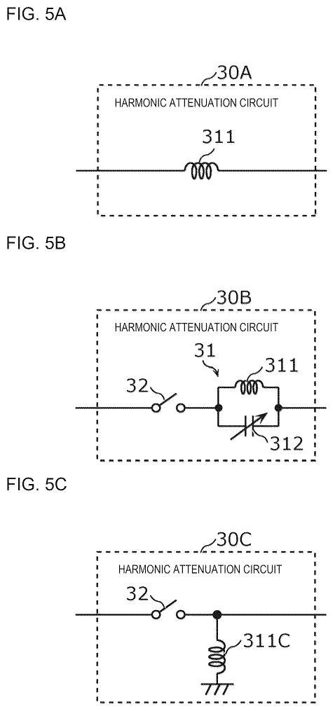

Next, Modification 1 of Embodiment 1 above is described. Modification 1 mainly differs from Embodiment 1 described above in the circuit configuration of the harmonic attenuation circuit. Modification 1 is described below with reference to FIG. 5A, focusing on the differences from Embodiment 1 described above.

FIG. 5A is a circuit diagram of a harmonic attenuation circuit 30A according to Modification 1. FIG. 5A illustrates an exemplary circuit configuration, and the harmonic attenuation circuit 30A can be implemented using any of a wide variety of circuit implementations and circuit technologies. Therefore, the following description of the harmonic attenuation circuit 30A should not be construed as limiting.

The harmonic attenuation circuit 30A is coupled between the matching circuit 20 and the switch circuit 40. Specifically, the input end of the harmonic attenuation circuit 30A is coupled to the output end of the matching circuit 20, while the output end of the harmonic attenuation circuit 30A is coupled to the common terminal 400 of the switch circuit 40. The harmonic attenuation circuit 30A can attenuate the harmonics of signals in the bands A and C.

In Modification 1, the harmonic attenuation circuit 30A includes the inductor 311 but does not include the capacitor 312, which is coupled in parallel to the inductor 311. The inductor 311 is coupled between the matching circuit 20 and the switch circuit 40.

As described above, the harmonic attenuation circuit 30A according to Modification 1 may include the inductor 311 may not to include the capacitor 312. Even in such a case, the harmonic attenuation circuit 30A can attenuate the harmonics.

### Modification 2 of Embodiment 1

Next, Modification 2 of Embodiment 1 described above is described. Modification 2 mainly differs from Embodiment 1 described above in the circuit configuration of the harmonic attenuation circuit. Modification 2 is described below with reference to FIG. 5B, focusing on the differences from Embodiment 1 described above.

FIG. 5B is a circuit diagram of a harmonic attenuation circuit 30B according to Modification 2. FIG. 5B illustrates an exemplary circuit configuration, and the harmonic attenuation circuit 30B can be implemented using any of a wide variety of circuit implementations and circuit technologies. Therefore, the following description of the harmonic attenuation circuit 30B should not be construed as limiting.

The harmonic attenuation circuit 30B is coupled between the matching circuit 20 and the switch circuit 40. Specifically, the input end of the harmonic attenuation circuit 30B is coupled to the output end of the matching circuit 20, and the output end of the harmonic attenuation circuit 30B is coupled to the common terminal 400 of the switch circuit 40. The harmonic attenuation circuit 30B can attenuate the harmonics of signals in the bands A and C.

In Modification 2, the harmonic attenuation circuit 30B includes a switch 32 in addition to the LC parallel circuit 31. The switch 32 is coupled between the matching circuit 20 and the LC parallel circuit 31.

As described above, the harmonic attenuation circuit 30B according to Modification 2 may include the switch 32, which is coupled between the matching circuit 20 and the LC parallel circuit 31. According to such a configuration, the switch 32 is opened in the second mode, so that the influence of the LC parallel circuit 31 on the signal path for the band B can be further reduced.

### Modification 3 of Embodiment 1

Next, Modification 3 of Embodiment 1 described above is described. Modification 3 mainly differs from Embodiment 1 described above in the circuit configuration of the harmonic attenuation circuit. Modification 3 is described below with reference to FIG. 5C, focusing on the differences from Embodiment 1 described above.

FIG. 5C is a circuit diagram of a harmonic attenuation circuit 30C according to Modification 3. FIG. 5C illustrates an exemplary circuit configuration, and the harmonic attenuation circuit 30C can be implemented using any of a wide variety of circuit implementations and circuit technologies. Therefore, the following description of the harmonic attenuation circuit 30C should not be construed as limiting.

The harmonic attenuation circuit 30C is coupled between the matching circuit 20 and the switch circuit 40. Specifically, the input end of the harmonic attenuation circuit 30C is coupled to the output end of the matching circuit 20, while the output end of the harmonic attenuation circuit 30C is coupled to the common terminal 400 of the switch circuit 40. The harmonic attenuation circuit 30C can attenuate the harmonics of signals in the bands A and C.

In Modification 3, the harmonic attenuation circuit 30C includes an inductor 311C and the switch 32. The inductor 311C is coupled between ground and the path connecting the matching circuit 20 and the switch circuit 40. The switch 32 is an example of a ninth switch and is coupled between the matching circuit 20 and the inductor 311C.

In FIG. 5C, the switch 32 is coupled between the matching circuit 20 and the switch circuit 40. However, the switch 32 may be coupled between the inductor 311C and the path connecting the matching circuit 20 and the switch circuit 40. The harmonic attenuation circuit 30C may further include a capacitor that is coupled to the inductor 311C in series between ground and the path connecting the matching circuit 20 and the switch circuit 40. Alternatively, instead of the inductor 311C, the harmonic attenuation circuit 30C may include a capacitor that is coupled between ground and the path connecting the matching circuit 20 and the switch circuit 40.

As described above, the harmonic attenuation circuit 30C according to Modification 3 may include: the inductor 311C, which is coupled between ground and the path connecting the matching circuit 20 and the switch 41; and the switch 32, which is coupled between the matching circuit 20 and the inductor 311C.

According to such a configuration, the switch 32 is opened in the second mode, so that the influence of the inductor 311C connected to ground on the signal path for the band B can be reduced. Furthermore, compared to the inductor 311, which is connected in series to the signal paths for the bands A and C, the inductor 311C, which is shunt-connected thereto, can more effectively reduce the pass band loss of signals in the bands A and C.

### Embodiment 2

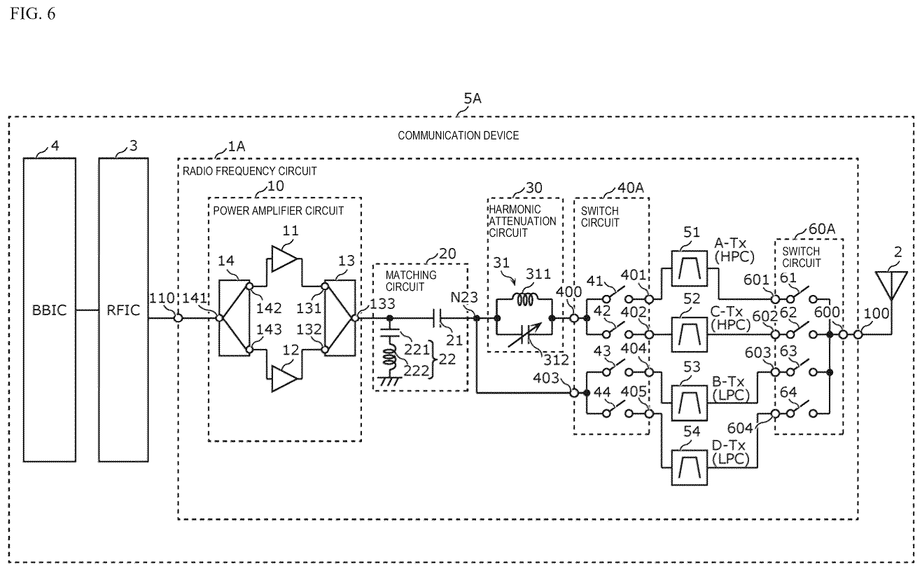

Next, Embodiment 2 is described. Embodiment 2 mainly differs from Embodiment 1 described above in that the radio frequency circuit further includes two filters. Embodiment 2 is described below with reference to FIG. 6, focusing on the differences from Embodiment 1 described above.

A communication device 5A according to Embodiment 2 is the same as the communication device 5 according to Embodiment 1 described above, except for including a radio frequency circuit 1A instead of the radio frequency circuit 1. The description thereof is omitted.

### 2.1. Circuit Configuration of Radio Frequency Circuit 1A

The circuit configuration of the radio frequency circuit 1A according to Embodiment 2 is described with reference to FIG. 6. FIG. 6 illustrates an exemplary circuit configuration, and the radio frequency circuit 1A can be implemented using any of a wide variety of circuit implementations and circuit technologies. Therefore, the following description of the radio frequency circuit 1A should not be construed as limiting.

The radio frequency circuit 1A includes a power amplifier circuit 10, a matching circuit 20, a harmonic attenuation circuit 30, switch circuits 40A and 60A, filters 51, 52, 53, and 54, an antenna connection terminal 100, and a RF input terminal 110.

### 2.1.1. Switch Circuit 40A

The switch circuit 40A is coupled between the harmonic attenuation circuit 30 and the filters 51 to 54. Specifically, the switch circuit 40A includes common terminals 400 and 403, selection terminals 401, 402, 404, and 405, and switches 41, 42, 43, and 44. The common terminal 400 is coupled to the output end of the harmonic attenuation circuit 30. The common terminal 403 is coupled to the output end of the matching circuit 20 not via the harmonic attenuation circuit 30. The selection terminal 401 is coupled to the filter 51; the selection terminal 402, the filter 52; the selection terminal 404, the filter 53; and the selection terminal 405, the filter 54.

The switch 41 is an example of the first switch and is coupled between the common terminal 400 and the selection terminal 401. That is, the switch 41 is coupled between the harmonic attenuation circuit 30 and the filter 51.

The switch 42 is an example of the fourth switch and is coupled between the common terminal 400 and the selection terminal 402. That is, the switch 42 is coupled between the harmonic attenuation circuit 30 and the filter 52. When the filter 52 is not included in the radio frequency circuit 1A, the switch 42 may not be included in the switch circuit 40A.

The switch 43 is an example of a sixth switch and is coupled between the common terminal 403 and the selection terminal 404. That is, the switch 43 is coupled between the matching circuit 20 and the filter 53 not via the harmonic attenuation circuit 30.

The switch 44 is an example of a seventh switch and is coupled between the common terminal 403 and the selection terminal 405. That is, the switch 44 is coupled between the matching circuit 20 and the filter 54 not via the harmonic attenuation circuit 30.

In such a connection configuration, the switch circuit 40A controls the switches 41 to 44 based on, for example, a control signal from the RFIC 3 to selectively connect the common terminal 400 to the selection terminals 401 and 402 and selectively connect the common terminal 403 to the selection terminals 404 and 405. That is, the switch circuit 40A is able to switch the connection of the harmonic attenuation circuit 30 between the filters 51 and 52 and switch the connection of the matching circuit 20 between the filters 53 and 54. The thus-configured switch circuit 40A is composed of, for example, a double-pole double-throw (DPDT) switch circuit.

The switch circuit 40A can be implemented in a semiconductor integrated circuit in a similar manner to the switch circuit 40.

The circuit configuration of the switch circuit 40A is not limited to that illustrated in FIG. 6. The switch circuit 40A may further include one or more additional common terminals and/or one or more additional selection terminals. In this case, the switch circuit 40A may further include one or more additional switches.

### 2.1.2. Filters 53 and 54

The filter 53 is an example of the third filter and is a band pass filter that has a pass band including the transmission band of the band B. The filter 53 is coupled between the switch circuits 40A and 60A. Specifically, one end of the filter 53 is coupled to the selection terminal 404 of the switch circuit 40A, while the other end of the filter 53 is coupled to a selection terminal 603 of the switch circuit 60A.

The filter 54 is an example of the fourth filter and is a band pass filter that has a pass band including the transmission band of the band D. The filter 54 is coupled between the switch circuits 40A and 60A. Specifically, one end of the filter 54 is coupled to the selection terminal 405 of the switch circuit 40A, while the other end of the filter 54 is coupled to a selection terminal 604 of the switch circuit 60A. The filter 54 may not be included in the radio frequency circuit 1A.

Each of the filters 53 and 54 may be a SAW filter, a BAW filter, an LC filter, a dielectric filter, or any combination of these filters and is not limited to these filters.

The filters 53 and 54 are not limited to band pass filters. The filters 53 and 54 may be partially or entirely composed of a band elimination filter, a high pass filter, or a low pass filter.

### 2.1.3. Switch Circuit 60A

The switch circuit 60A is coupled between the antenna connection terminal 100 and the filters 51 to 54. Specifically, the switch circuit 60A includes a common terminal 600, selection terminals 601 and 602, the selection terminals 603 and 604, and switches 61, 62, 63, and 64. The common terminal 600 is coupled to the antenna connection terminal 100. The selection terminal 601 is coupled to the filter 51; the selection terminal 602, the filter 52; the selection terminal 603, the filter 53; and the selection terminal 604, the filter 54.

The switch 61 is an example of the second switch and is coupled between the common terminal 600 and the selection terminal 601. That is, the switch 61 is coupled between the antenna connection terminal 100 and the filter 51.

The switch 62 is an example of the fifth switch and is coupled between the common terminal 600 and the selection terminal 602. That is, the switch 62 is coupled between the antenna connection terminal 100 and the filter 52. When the filter 52 is not included in the radio frequency circuit 1A, the switch 62 may not be included in the switch circuit 60A.

The switch 63 is an example of the third switch and is coupled between the common terminal 600 and the selection terminal 603. That is, the switch 63 is coupled between the antenna connection terminal 100 and the filter 53.

The switch 64 is an example of an eighth switch and is coupled between the common terminal 600 and the selection terminal 604. That is, the switch 64 is coupled between the antenna connection terminal 100 and the filter 54.

In such a connection configuration, the switch circuit 60A controls the switches 61 to 64 based on, for example, a control signal from the RFIC 3 to selectively connect the common terminal 600 to the selection terminals 601 to 604.

That is, the switch circuit 60A is able to switch the connection of the antenna connection terminal 100 between the filters 51 to 54. The thus-configured switch circuit 60A is composed of, for example, a single-pole quadruple-throw (SP4T) switch circuit.

The switch circuit 60A can be implemented in a semiconductor integrated circuit in a similar manner to the switch circuit 60.

The circuit configuration of the switch circuit 60A is not limited to that illustrated in FIG. 6. The switch circuit 60A may further include one or more additional common terminals and/or one or more additional selection terminals. In this case, the switch circuit 60A may further include one or more additional switches.

### 2.2. Frequency Band

Next, bands A, B, C, and D supported by the communication device 5A are described.

The bands A to D are frequency bands for a communication system built using RAT. The bands A to D are predefined by a standardizing body, such as 3GPP or IEEE. Examples of the communication system include 5G NR systems, 4G LTE systems, and 2G GSM systems.

In Embodiment 2, the bands A and C are examples of the first and third bands, respectively, and are 5G NR bands that correspond to the first and second power classes. The bands B and D are examples of the second and fourth bands, respectively, and are 5G NR bands that correspond to the second power class but not to the first power class. The bands A to D may be partially or entirely a 4G LTE band.

The first power class is specified by the first maximum output power, which is higher than the second maximum output power, and is referred to as a high-power class (HPC) in Embodiment 2. The second power class is specified by the second maximum output power, which is lower than the first maximum output power, and is referred to as a low-power class (LPC) in Embodiment 2. For example, the first power class is Power Class 2 or 1.5, and the second power class is Power Class 3.

### 2.3. Plurality of Communication Modes of Communication Device 5A

Next, a plurality of communication modes of the communication device 5A is described.

### 2.3.1. First Mode

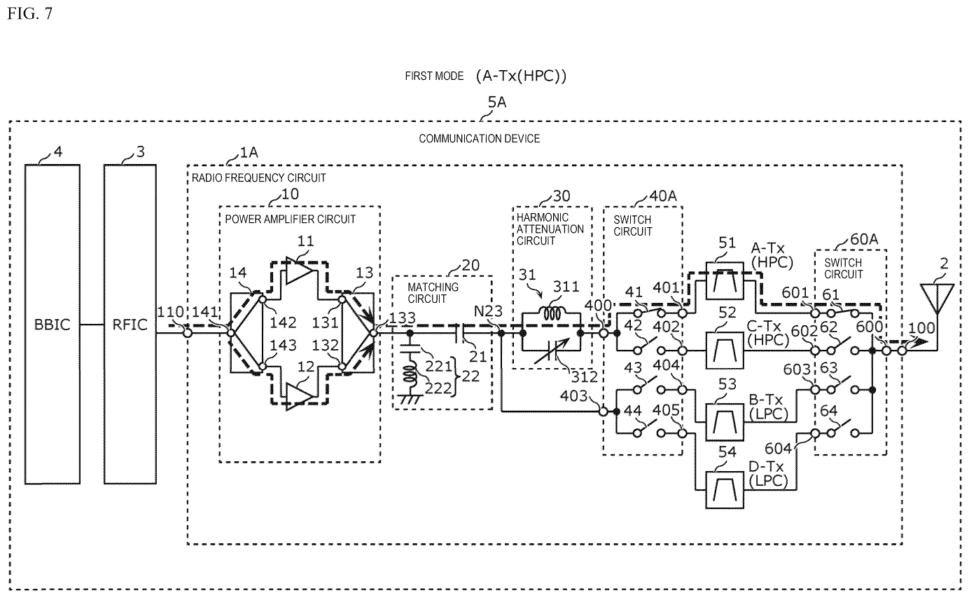

First, a first mode included in the plurality of communication modes is described with reference to FIG. 7. The first mode is a communication mode for transmitting a radio frequency signal (an example of the first radio frequency signal) in the transmission band of the band A with HPC or LPC. In the first mode, the first radio frequency signal is routed through a primary signal path that includes the harmonic attenuation circuit 30 to ensure attenuation of harmonics.

In the first mode, the switch circuit 40A connects the common terminal 400 to the selection terminal 401, does not connect the common terminal 400 to the selection terminal 402, and does not connect the common terminal 403 to the selection terminal 404 or 405. That is, the switch 41 is closed, while the switches 42 to 44 are opened. The switch circuit 60A connects the common terminal 600 to the selection terminal 601 and does not connect the common terminal 600 to the selection terminal 602, 603, or 604. That is, the switch 61 is closed, while the switches 62 to 64 are opened.

Therefore, a transmission signal in the band A is transmitted from the RFIC 3 to the antenna 2 via the RF input terminal 110, the power amplifier circuit 10, the matching circuit 20, the harmonic attenuation circuit 30, the switch circuit 40A, the filter 51, the switch circuit 60A, and the antenna connection terminal 100.

During this process, the capacitor 312 of the harmonic attenuation circuit 30 is controlled to a first electrostatic capacity, so that the resonant frequency of the LC parallel circuit 31 is included in the harmonic bands of the transmission band of the band A. As a result, the harmonic attenuation circuit 30 can effectively attenuate signals in the harmonic bands of the transmission band of the band A.

### 2.3.2. Second Mode

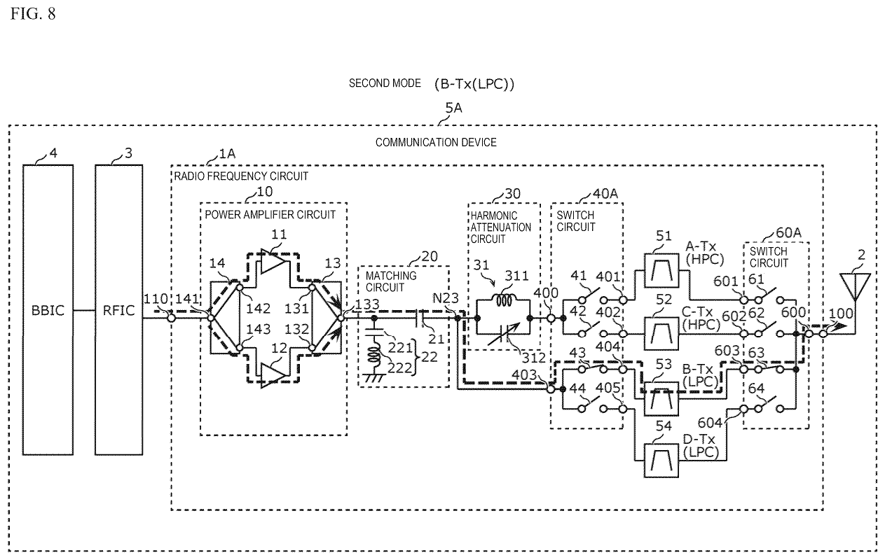

Next, a second mode included in the plurality of communication modes is described with reference to FIG. 8. The second mode is a communication mode for transmitting a radio frequency signal (an example of the second radio frequency signal) in the transmission band of the band B with LPC. In the second mode, the second radio frequency signal is routed through a bypass signal path that bypasses the harmonic attenuation circuit 30, thereby reducing pass band loss for the second radio frequency signal.

In the second mode, the switch circuit 40A connects the common terminal 403 to the selection terminal 404, does not connect the common terminal 403 to the selection terminal 405, and does not connect the common terminal 400 to the selection terminal 401 or 402. That is, the switch 43 is closed, and the switches 41, 42, and 44 are opened. The switch circuit 60A connects the common terminal 600 to the selection terminal 603 and does not connect the common terminal 600 to the selection terminal 601, 602, or 604. That is, the switch 63 is closed, while the switches 61, 62, and 64 are opened.

Therefore, a transmission signal in the band B is transmitted from the RFIC 3 to the antenna 2 via the RF input terminal 110, the power amplifier circuit 10, the matching circuit 20, the switch circuit 40A, the filter 53, the switch circuit 60A, and the antenna connection terminal 100. That is, the transmission signal in the band B is transmitted to the antenna 2 without passing through the harmonic attenuation circuit 30.

### 2.3.3. Third Mode

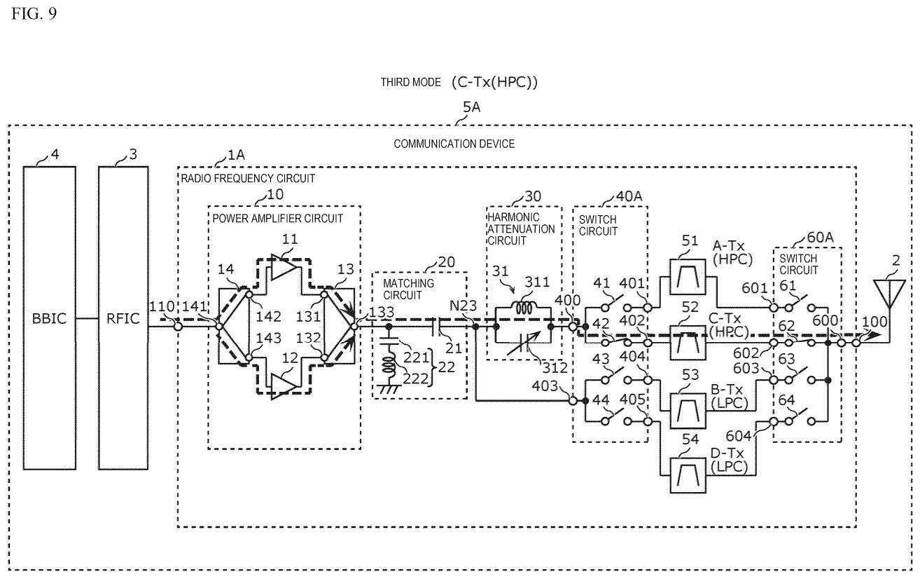

Next, a third mode included in the plurality of communication modes is described with reference to FIG. 9. The third mode is a communication mode for transmitting a radio frequency signal (an example of the third radio frequency signal) in the transmission band of the band C with HPC or LPC. In the third mode, the third radio frequency signal is routed through a primary signal path that includes the harmonic attenuation circuit 30 to ensure attenuation of harmonics.

In the third mode, the switch circuit 40A connects the common terminal 400 to the selection terminal 402, does not connect the common terminal 400 to the selection terminal 401, and does not connect the common terminal 403 to the selection terminal 404 or 405. That is, the switch 42 is closed, while the switches 41, 43, and 44 are opened. The switch circuit 60A connects the common terminal 600 to the selection terminal 602 and does not connect the common terminal 600 to the selection terminal 601, 603, or 604. That is, the switch 62 is closed, while the switches 61, 63, and 64 are opened.

Therefore, a transmission signal in the band C is transmitted from the RFIC 3 to the antenna 2 via the RF input terminal 110, the power amplifier circuit 10, the matching circuit 20, the harmonic attenuation circuit 30, the switch circuit 40A, the filter 52, the switch circuit 60A, and the antenna connection terminal 100.

During this process, the capacitor 312 of the harmonic attenuation circuit 30 is controlled to a third electrostatic capacity, so that the resonant frequency of the LC parallel circuit 31 is included in the harmonic bands of the transmission band of the band C. As a result, the harmonic attenuation circuit 30 can effectively attenuate signals in the harmonic bands of the transmission band of the band C.

### 2.3.4. Fourth Mode

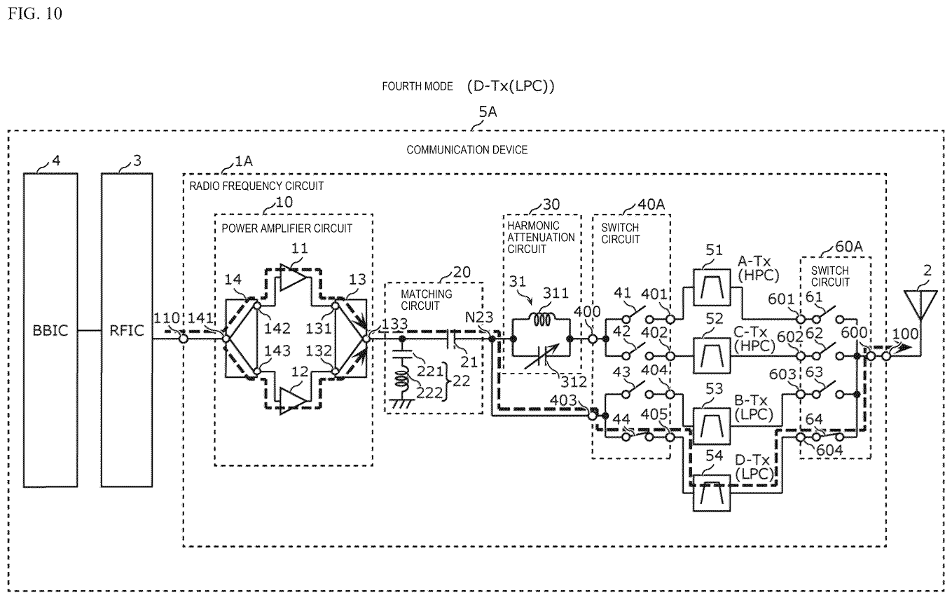

Next, a fourth mode included in the plurality of communication modes is described with reference to FIG. 10. The fourth mode is a communication mode for transmitting a radio frequency signal (an example of a fourth radio frequency signal) in the transmission band of the band D with LPC. In the fourth mode, the fourth radio frequency signal is routed through a bypass signal path that bypasses the harmonic attenuation circuit 30, thereby reducing pass band loss for the fourth radio frequency signal.

In the fourth mode, the switch circuit 40A connects the common terminal 403 to the selection terminal 405, does not connect the common terminal 403 to the selection terminal 404, and does not connect the common terminal 400 to the selection terminal 401 or 402. That is, the switch 44 is closed, while the switches 41, 42, and 43 are opened. The switch circuit 60A connects the common terminal 600 to the selection terminal 604 and does not connect the common terminal 600 to the selection terminal 601, 602, or 603. That is, the switch 64 is closed, while the switches 61, 62, and 63 are opened.

Therefore, a transmission signal in the band D is transmitted from the RFIC 3 to the antenna 2 via the RF input terminal 110, the power amplifier circuit 10, the matching circuit 20, the switch circuit 40A, the filter 54, the switch circuit 60A, and the antenna connection terminal 100. That is, the transmission signal in the band D is transmitted to the antenna 2 without passing through the harmonic attenuation circuit 30.

### 2.4. Conclusion

As described above, the radio frequency circuit 1A according to Embodiment 2 includes: the power amplifier circuit 10; the harmonic attenuation circuit 30, which has an attenuation band including at least part of the harmonic bands of the transmission band of the band A; the matching circuit 20, which is coupled between the harmonic attenuation circuit 30 and the power amplifier circuit 10; the filter 51, which has a pass band including the transmission band of the band A; the switch 41, which is coupled between the harmonic attenuation circuit 30 and the filter 51; the switch 61, which is coupled between the filter 51 and the antenna connection terminal 100; and the switch 63, which is coupled between the matching circuit 20 and the antenna connection terminal 100 not via the harmonic attenuation circuit 30.

According to such a configuration, the matching circuit coupled to the output end of the power amplifier circuit 10 is divided into the matching circuit 20 and the harmonic attenuation circuit 30, thereby implementing the transmit path that couples the matching circuit 20 to the antenna connection terminal 100 not via the harmonic attenuation circuit 30. The transmit path that couples the matching circuit 20 to the antenna connection terminal 100 via the harmonic attenuation circuit 30 and the transmit path that couples the matching circuit 20 to the antenna connection terminal 100 not via the harmonic attenuation circuit 30 can be switched by the switches 41, 61, and 63. Therefore, radio frequency signals with stringent harmonic attenuation requirements are transmitted using the transmit path that couples the matching circuit 20 to the antenna connection terminal 100 via the harmonic attenuation circuit 30. This can satisfy the harmonic attenuation requirements. On the other hand, radio frequency signals with less stringent harmonic attenuation requirements are transmitted using the transmit path that couples the matching circuit 20 to the antenna connection terminal 100 not via the harmonic attenuation circuit 30. This can reduce the pass band loss of radio frequency signals in the harmonic attenuation circuit 30. That is, the radio frequency circuit 1A can reduce the pass band loss of radio frequency signals in the harmonic attenuation circuit 30 while satisfying the harmonic attenuation requirements.

In the radio frequency circuit 1A according to Embodiment 2, for example, the harmonic attenuation circuit 30 may include an inductor coupled between the matching circuit 20 and the switch 41 and may not include a ground connection.

According to such a configuration, the harmonic attenuation circuit 30 does not include a ground connection. Therefore, when the switch 41 is opened and the switch 63 is closed, the influence of the harmonic attenuation circuit 30 on the signal path for the band B can be reduced even if the harmonic attenuation circuit 30 does not include a switch. Furthermore, because the inductor 311 is coupled between the matching circuit 20 and the switch 41, the pass band loss in the inductor 311 is high, and the pass band loss of radio frequency signals in the harmonic attenuation circuit 30 can be reduced effectively.

For example, the radio frequency circuit 1A according to Embodiment 2 may further include: the filter 52, which has a pass band including the transmission band of the band C; the switch 42, which is coupled between the harmonic attenuation circuit 30 and the filter 52; and the switch 62, which is coupled between the filter 52 and the antenna connection terminal 100.

According to such a configuration, radio frequency signals in the band C can be transmitted via the harmonic attenuation circuit 30. Therefore, the harmonic attenuation requirements can be satisfied during the transmission of signals in the band C, in addition to the band A, and during the transmission of signals in the band B, the pass band loss of signals in the band B in the harmonic attenuation circuit 30 can be reduced.

For example, the radio frequency circuit 1A according to Embodiment 2 may further include: the switch 43, which is coupled between the matching circuit 20 and the switch 63 not via the harmonic attenuation circuit 30; and the filter 53, which is coupled between the switch 63 and the switch 43 and has a pass band including the transmission band of the band B.

According to such a configuration, signals in the band B can be transmitted via the filter 53. This can reduce spurious emissions during the transmission of signals in the band B.

For example, the radio frequency circuit 1A according to Embodiment 2 may further include: the filter 54, which has a pass band including the transmission band of the band D; the switch 44, which is coupled between the matching circuit 20 and the filter 54 not via the harmonic attenuation circuit 30; and the switch 64, which is coupled between the filter 54 and the antenna connection terminal 100.

According to such a configuration, radio frequency signals in the band D can be transmitted without passing through the harmonic attenuation circuit 30. This can reduce the pass band loss of signals in the band D in the harmonic attenuation circuit 30 during the transmission of signals in the band D, in addition to the band B.

In the radio frequency circuit 1A according to Embodiment 2, for example, in the first mode for transmitting the first radio frequency signal in the transmission band of the band A, the switches 41 and 61 may be closed, the switches 42, 62, 43, 63, 44, and 64 may be opened. In the second mode for transmitting the second radio frequency signal in the transmission band of the band B, the switches 63 and 43 may be closed, and the switches 41, 61, 42, 62, 44, and 64 may be opened. In the third mode for transmitting the third radio frequency signal in the transmission band of the band C, the switches 42 and 62 may be closed, and the switches 41, 61, 43, 63, 44, and 64 may be opened. In the fourth mode for transmitting the fourth radio frequency signal in the transmission band of the band D, the switches 44 and 64 may be closed, and the switches 41, 61, 42, 62, 43, and 63 may be opened.

According to such a configuration, by using the first and third modes when harmonic attenuation requirements are stringent, radio frequency signals can be transmitted via the harmonic attenuation circuit 30. On the other hand, by using the second and fourth modes when the harmonic attenuation requirements are less stringent, radio frequency signals can be transmitted without passing through the harmonic attenuation circuit 30. Therefore, during the transmission of the first and third radio frequency signals with stringent harmonic attenuation requirements, the harmonic attenuation requirements are satisfied. During the transmission of the second and fourth radio frequency signals with less stringent harmonic attenuation requirements, the pass band loss of radio frequency signals in the harmonic attenuation circuit 30 can be reduced.

In the radio frequency circuit 1A according to Embodiment 2, for example, the bands A and C may be 5G NR bands or 4G LTE bands that correspond to the first power class specified by the first maximum output power and the second power class specified by the second maximum output power, which is lower than the first maximum output power. The bands B and D may be 5G NR bands or 4G LTE bands that correspond to the second power class but not to the first power class.

According to such a configuration, in the first power class with more stringent harmonic attenuation requirements, the harmonic attenuation requirements can be satisfied, and in the second power class with more lenient harmonic attenuation requirements, the pass band loss of radio frequency signals can be reduced.

In the radio frequency circuit 1A according to Embodiment 2, for example, the harmonic attenuation circuit 30 may include the LC parallel circuit 31, which is coupled between the matching circuit 20 and the switch 41.

According to such a configuration, the harmonics can be attenuated by the LC parallel circuit 31.

In the radio frequency circuit 1A according to Embodiment 2, for example, the matching circuit 20 may include the capacitor 21, which is coupled between the power amplifier circuit 10 and the harmonic attenuation circuit 30.

According to such a configuration, the direct-current component can be cut off by the matching circuit 20.

In the radio frequency circuit 1A according to Embodiment 2, for example, the matching circuit 20 may include the LC series circuit 22, which is coupled between ground and the path connecting the power amplifier circuit 10 and the harmonic attenuation circuit 30.

According to such a configuration, radio frequency distortion can be attenuated by the matching circuit 20 as well.

In the radio frequency circuit 1A according to Embodiment 2, for example, the power amplifier circuit 10 may include: the power amplifiers 11 and 12; the input terminal 131, which is coupled to the output end of the power amplifier 11; the input terminal 132, which is coupled to the output end of the power amplifier 12; and the combiner 13, which includes the output terminal 133 coupled to the matching circuit 20.

According to such a configuration, radio frequency signals can be amplified by the power amplifiers 11 and 12, which are coupled in parallel, thereby enabling the radio frequency circuit 1A to accommodate higher output power.

### Other Embodiment

Hereinabove, the radio frequency circuit according to the present disclosure is described based on the embodiments but is not limited to the aforementioned embodiments. The present disclosure includes another embodiment implemented by any combination of the constituent elements according to the aforementioned embodiments, modifications obtained by applying various modifications conceivable by those skilled in the art to the aforementioned embodiments without departing from the gist of the present disclosure, and various devices incorporating the aforementioned radio frequency circuit.

For example, in the circuit configuration of the radio frequency circuit according to each of the aforementioned embodiments, another circuit element, wiring, or the like may be inserted between paths connecting the circuit elements and signal paths disclosed in the drawings. For example, another impedance matching circuit may be coupled between the switch circuit 60 and the filters 51 and 52. In another example, a coupler may be coupled between the switch circuit 60 and the antenna connection terminal 100.

For example, Modifications 1 to 3 of Embodiment 1 may be applied to Embodiment 2. That is, the radio frequency circuit 1A may include the harmonic attenuation circuit 30A, 30B, or 30C, instead of the harmonic attenuation circuit 30. The following description illustrates the features of the radio frequency circuits described based on the embodiments.

<1> A radio frequency circuit including:
a power amplifier circuit;
a harmonic attenuation circuit that has an attenuation band including at least part of harmonic bands of a transmission band of a first band;
a matching circuit coupled between the harmonic attenuation circuit and the power amplifier circuit;
a first filter that has a pass band including the transmission band of the first band;
a first switch coupled between the harmonic attenuation circuit and the first filter;
a second switch coupled between the first filter and an antenna connection terminal; and
a third switch coupled between the matching circuit and the antenna connection terminal not via the harmonic attenuation circuit.

<2> The radio frequency circuit according to <1>, in which the harmonic attenuation circuit includes an inductor coupled between the matching circuit and the first switch and does not include a ground connection.

<3> The radio frequency circuit according to <1> or <2>, in which
in a first mode for transmitting a first radio frequency signal in the transmission band of the first band, the first switch and the second switch are closed, and the third switch is opened, and
in a second mode for transmitting a second radio frequency signal in a transmission band of a second band, the third switch is closed, and the first switch and the second switch are opened.

<4> The radio frequency circuit according to <3>, in which
the first band is a 5G NR band or a 4G LTE band, and
the second band is a 2G GSM band. <5> The radio frequency circuit according to <3>, in which
the first band and the second band are 5G NR bands or 4G LTE bands, and
a maximum output power of the first radio frequency signal is higher than a maximum output power of the second radio frequency signal.

<6> The radio frequency circuit according to <4> or <5>, further including:
a second filter that has a pass band including a transmission band of a third band;
a fourth switch coupled between the harmonic attenuation circuit and the second filter; and
a fifth switch coupled between the second filter and the antenna connection terminal.

<7> The radio frequency circuit according to <6>, in which
in a third mode for transmitting a third radio frequency signal in the transmission band of the third band, the fourth switch and the fifth switch are closed, and the first switch, the second switch, and the third switch are opened.

<8> The radio frequency circuit according to <1> or <2>, further including:
a second filter that has a pass band including a transmission band of a third band;
a fourth switch coupled between the harmonic attenuation circuit and the second filter; and
a fifth switch coupled between the second filter and the antenna connection terminal.

<9> The radio frequency circuit according to <8>, further including:
a sixth switch coupled between the matching circuit and the third switch not via the harmonic attenuation circuit; and
a third filter that is coupled between the third switch and the sixth switch and has a pass band including a transmission band of a second band.

<10> The radio frequency circuit according to <9>, further including:
a fourth filter that has a pass band including a transmission band of a fourth band;
a seventh switch coupled between the matching circuit and the fourth filter not via the harmonic attenuation circuit; and
an eighth switch coupled between the fourth filter and the antenna connection terminal.

<11> The radio frequency circuit according to <10>, in which
in a first mode for transmitting a first radio frequency signal in the transmission band of the first band, the first switch and the second switch are closed, and the third switch, the fourth switch, the fifth switch, the sixth switch, the seventh switch, and the eighth switch are opened,
in a second mode for transmitting a second radio frequency signal in the transmission band of the second band, the third switch and the sixth switch are closed, and the first switch, the second switch, the fourth switch, the fifth switch, the seventh switch, and the eighth switch are opened,
in a third mode for transmitting a third radio frequency signal in the transmission band of the third band, the fourth switch and the fifth switch are closed, and the first switch, the second switch, the third switch, the sixth switch, the seventh switch, and the eighth switch are opened, and
in a fourth mode for transmitting a fourth radio frequency signal in the transmission band of the fourth band, the seventh switch and the eighth switch are closed, and the first switch, the second switch, the third switch, the fourth switch, the fifth switch, and the sixth switch are opened.

### <12> the Radio Frequency Circuit According to <11>, in which

the first band and the third band are 5G NR bands or 4G LTE bands that correspond to a first power class specified by a first maximum output power and a second power class specified by a second maximum output power, which is lower than the first maximum output power, and
the second band and the fourth band are 5G NR bands or 4G LTE bands that correspond to the second power class and do not correspond to the first power class.

<13> The radio frequency circuit according to any one of <1> to <12>, in which the harmonic attenuation circuit includes an LC parallel circuit coupled between the matching circuit and the first switch.

<14> The radio frequency circuit according to <13>, in which a capacitor of the LC parallel circuit is a variable capacitor.

<15> The radio frequency circuit according to <14>, in which
in a first mode for transmitting a first radio frequency signal in the transmission band of the first band, the variable capacitor is controlled to a first electrostatic capacity, and in a second mode for transmitting a second radio frequency signal in a transmission band of a second band, the variable capacitor is controlled to a second electrostatic capacity, which is greater than the first electrostatic capacity.

<16> The radio frequency circuit according to <15>, in which
in the first mode for transmitting the first radio frequency signal in the transmission band of the first band, the variable capacitor is controlled to the first electrostatic capacity so that a resonant frequency of the LC parallel circuit is included in the harmonic bands of the transmission band of the first band, and
in the second mode for transmitting the second radio frequency signal in the transmission band of the second band, the variable capacitor is controlled to the second electrostatic capacity so that the resonant frequency of the LC parallel circuit is included in the transmission band of the second band.

<17> The radio frequency circuit according to <1>, in which the harmonic attenuation circuit includes
at least one of an inductor and a capacitor coupled between ground and a path connecting the matching circuit and the first switch, and
a ninth switch coupled between the matching circuit and the at least one of the inductor and the capacitor.

<18> The radio frequency circuit according to any one of <1> to <17>, in which the matching circuit includes a capacitor coupled between the power amplifier circuit and the harmonic attenuation circuit.

<19> The radio frequency circuit according to any one of <1> to <18>, in which the matching circuit includes an LC series circuit coupled between ground and a path connecting the power amplifier circuit and the harmonic attenuation circuit.

<20> The radio frequency circuit according to any one of <1> to <19>, in which the power amplifier circuit includes
a first power amplifier,
a second power amplifier, and
a combiner including a first input terminal coupled to an output end of the first power amplifier, a second input terminal coupled to an output end of the second power amplifier, and an output terminal coupled to the matching circuit.

The present invention is widely applicable to communication devices, such as mobile phones, as the radio frequency circuit disposed in the front end.

What is claimed is:

1. A radio frequency circuit comprising:
a power amplifier circuit;
a harmonic attenuation circuit that has an attenuation band including at least part of harmonic bands of a transmission band of a first band;
a matching circuit coupled between the harmonic attenuation circuit and the power amplifier circuit;
a first filter that has a pass band including the transmission band of the first band;
a first switch coupled between the harmonic attenuation circuit and the first filter;
a second switch coupled between the first filter and an antenna connection terminal; and
a third switch coupled between the matching circuit and the antenna connection terminal not via the harmonic attenuation circuit.

2. The radio frequency circuit according to claim 1, wherein the harmonic attenuation circuit includes an inductor coupled between the matching circuit and the first switch and does not include a ground connection.

3. The radio frequency circuit according to claim 1, wherein
in a first mode for transmitting a first radio frequency signal in the transmission band of the first band, the first switch and the second switch are closed, and the third switch is opened, and
in a second mode for transmitting a second radio frequency signal in a transmission band of a second band, the third switch is closed, and the first switch and the second switch are opened.

4. The radio frequency circuit according to claim 3, wherein
the first band is a 5G NR band or a 4G LTE band, and
the second band is a 2G GSM band.

5. The radio frequency circuit according to claim 3, wherein
the first band and the second band are 5G NR bands or 4G LTE bands, and
a maximum output power of the first radio frequency signal is higher than a maximum output power of the second radio frequency signal.

6. The radio frequency circuit according to claim 4, further comprising:
a second filter that has a pass band including a transmission band of a third band;
a fourth switch coupled between the harmonic attenuation circuit and the second filter; and
a fifth switch coupled between the second filter and the antenna connection terminal.

7. The radio frequency circuit according to claim 6, wherein
in a third mode for transmitting a third radio frequency signal in the transmission band of the third band, the fourth switch and the fifth switch are closed, and the first switch, the second switch, and the third switch are opened.

8. The radio frequency circuit according to claim 1, further comprising:
a second filter that has a pass band including a transmission band of a third band;
a fourth switch coupled between the harmonic attenuation circuit and the second filter; and
a fifth switch coupled between the second filter and the antenna connection terminal.

9. The radio frequency circuit according to claim 8, further comprising:
a sixth switch coupled between the matching circuit and the third switch not via the harmonic attenuation circuit; and
a third filter that is coupled between the third switch and the sixth switch and has a pass band including a transmission band of a second band.

10. The radio frequency circuit according to claim 9, further comprising:
a fourth filter that has a pass band including a transmission band of a fourth band;
a seventh switch coupled between the matching circuit and the fourth filter not via the harmonic attenuation circuit; and
an eighth switch coupled between the fourth filter and the antenna connection terminal.

11. The radio frequency circuit according to claim 10, wherein
in a first mode for transmitting a first radio frequency signal in the transmission band of the first band, the first switch and the second switch are closed, and the third switch, the fourth switch, the fifth switch, the sixth switch, the seventh switch, and the eighth switch are opened,
in a second mode for transmitting a second radio frequency signal in the transmission band of the second band, the third switch and the sixth switch are closed, and the first switch, the second switch, the fourth switch, the fifth switch, the seventh switch, and the eighth switch are opened,
in a third mode for transmitting a third radio frequency signal in the transmission band of the third band, the fourth switch and the fifth switch are closed, and the first switch, the second switch, the third switch, the sixth switch, the seventh switch, and the eighth switch are opened, and
in a fourth mode for transmitting a fourth radio frequency signal in the transmission band of the fourth band, the seventh switch and the eighth switch are closed, and the first switch, the second switch, the third switch, the fourth switch, the fifth switch, and the sixth switch are opened.

12. The radio frequency circuit according to claim 11, wherein
the first band and the third band are 5G NR bands or 4G LTE bands that correspond to a first power class specified by a first maximum output power and a second power class specified by a second maximum output power, which is lower than the first maximum output power, and
the second band and the fourth band are 5G NR bands or 4G LTE bands that correspond to the second power class and do not correspond to the first power class.

13. The radio frequency circuit according to claim 1, wherein the harmonic attenuation circuit includes an LC parallel circuit coupled between the matching circuit and the first switch.

14. The radio frequency circuit according to claim 13, wherein a capacitor of the LC parallel circuit is a variable capacitor.

15. The radio frequency circuit according to claim 14, wherein
in a first mode for transmitting a first radio frequency signal in the transmission band of the first band, the variable capacitor is controlled to a first electrostatic capacity, and in a second mode for transmitting a second radio frequency signal in a transmission band of a second band, the variable capacitor is controlled to a second electrostatic capacity, which is greater than the first electrostatic capacity.

16. The radio frequency circuit according to claim 15, wherein
in the first mode for transmitting the first radio frequency signal in the transmission band of the first band, the variable capacitor is controlled to the first electrostatic capacity so that a resonant frequency of the LC parallel circuit is included in the harmonic bands of the transmission band of the first band, and
in the second mode for transmitting the second radio frequency signal in the transmission band of the second band, the variable capacitor is controlled to the second electrostatic capacity so that the resonant frequency of the LC parallel circuit is included in the transmission band of the second band.

17. The radio frequency circuit according to claim 1, wherein the harmonic attenuation circuit includes
at least one of an inductor and a capacitor coupled between ground and a path connecting the matching circuit and the first switch, and
a ninth switch coupled between the matching circuit and the at least one of the inductor and the capacitor.

18. The radio frequency circuit according to claim 1, wherein the matching circuit includes a capacitor coupled between the power amplifier circuit and the harmonic attenuation circuit.

19. The radio frequency circuit according to claim 1, wherein the matching circuit includes an LC series circuit coupled between ground and a path connecting the power amplifier circuit and the harmonic attenuation circuit.

20. A radio frequency circuit, comprising:
a power amplifier circuit having an input coupled to a radio frequency integrated circuit and an output;
a matching circuit coupled to the output of the power amplifier circuit;
a first signal path coupled to the matching circuit, the first signal path including a harmonic attenuation circuit and a first filter;
a second signal path coupled to the matching circuit, wherein the second signal path bypasses the harmonic attenuation circuit; and
a switch circuit configured to selectively route a radio frequency signal from the matching circuit through either the first signal path or the second signal path to an antenna connection terminal.
